(19) United States
(12) Patent Application Publication
(10) Pub. No.: US 2003/0167211 A1
(43) Pub. Date: Sep. 4, 2003

(54) Method and apparatus for digitally marking media content

(76) Inventor: Marco Scibora, St. Paul, MN (US)

Correspondence Address: BRIGGS AND MORGAN, P.A., 2400 IDS CENTER, MINNEAPOLIS, MN, 55402, US

(21) Appl. No.: 10/090,906

(22) Filed: Mar. 4, 2002

(51) Int. Cl. G06F 17/60

(52) U.S. Cl. 705/26

(57) ABSTRACT

An apparatus and method allowing a consumer to digitally mark media content and later retrieve portions of the marked media content keyed to that consumer. The apparatus includes storage for the media content; a server computer accessing the media content storage; a workstation interacting with the server computer to allow the consumer to sample portions of the stored media content; a plurality of portable digital markers having a unique barcode; and a database containing the unique barcodes and references to the sampled portions of the stored media content.

### BACKGROUND OF THE INVENTION

This invention relates to a technology in which the retail shoppers are able to “mark” music CD(s), DVD videos, games, etc. while sampling a music CD or viewing DVD videos and games. This technology, referred to as Digital Marking (DM) can be integrated into any computer-based music/video/game sampling/distribution technologies installed and utilized inside physical retail stores.

In the past few years many major specialty retailers including national department and discount chains began installing computer-based music/video/games sampling technology to allow their shoppers to sample music/video/games before purchasing. This powerful technology provides an easy and economical means to equip any retail store with a large volume of digital sampling content for instant delivery of digital sampling. In addition, through various digital distribution technologies a multiplicity of interactive stations can be installed, allowing simultaneous delivery of digital content to many shoppers. It is highly desirable that the library of digital samples (music CDs, DVD video, games, etc.) matches the in-store inventory of every CD, DVD Video or Game or other digital product available for sale.

Many technologies exist to provide shoppers with various means of triggering the delivery of the desired sample(s). They vary from keypads (similar to a telephone); touch screens, magnetic card readers and scanners. To allow simple and most intuitive use, scanner technology is the most popular means to trigger digital sampling sessions. The use of scanning technology provides shopper with an instant delivery of digital sampling by simply scanning a product's barcode. Such technology allows the retailer to provide easy sampling of literally thousands of music CDs, DVD videos and games, without the need of searching techniques, spelling and multiple screen confusion plagued with touch screen technologies.

This invention could allow retailers to offer their shoppers other valuable services beyond sampling only. This invention allows shoppers not only to sample but also to mark the sampled product for future reference. Such a service affords valuable benefits to the shoppers as well as the retailer.

### SUMMARY OF THE INVENTION

The following elements of the digital marking are preferably part of the invention, although equivalent embodiments are within the claims:

Main Computer 12—in-store and/or remote, with large storage facilities (hard drives, DVDs, CDROM, etc.) performing a function of a main server supporting a multiplicity of interactive stations 14, or a single computer serving as an interactive sampling station. All sampling stations can be but do not have to be connected to the computer either via hard wire or wireless technologies and either with or without the need of a network.

Interactive Station 14—an interactive device (computer, thin client, networked and non-networked) placed on the retail floor for shoppers to use equipped with scanners, user interface (such as screen, touch screen, buttons, etc.) and other peripherals. The interactive station 14 may also include a main computer 12.

Digital Content—virtually unlimited amount of digital content (compressed or not) stored on hard drive(s), either on retail premises or off premises, or a combination of both.

Sampling Content Database (part of The Digital Content)—comprised of pertinent information such as barcode, product type, media, etc. related to the unique product number (barcode).

Shopper's Reference Database—comprised of pertinent information such us all unique identifier barcodes, shopper's names and other information (only if registered), etc.

Software Program—managing all references made by the shopper while sampling and digitally marking selected products.

Digital Marker—a paper, plastic, etc. card with printed barcode (or other identifier), instruction on how to use it and other promotional material.

There are two ways of providing the services of Digital Marking:

Anonymous Digital Marking—this method allows the retailer to provide digital marking services without obtaining any information about their shopper. The use of the service would be totally anonymous. The retailer would print thousands of Digital Markers readily available within a retail floor either near each cash register, at the service desk or at a sampling station.

Shoppers could pick up the Digital Marker 30 and use it at any time without giving up any personal information to anyone. Scanning the barcode of the Digital Marker while sampling audio, video or games allows the shopper to mark his/her product he has an interest in but is not ready to purchase. Similar to what is better know as a “tickler file”, this service allows the shopper to have a reference of his past shopping at a later day by having the ability review what product he/she marked.

After the shopper marks his/her product of interest, it gives the retailer a great opportunity to provide additional services by inviting them to come back and view and sample product recommendation based on their earlier choices of preferences. The shopper will be able to view, sample or delete the recommendations. The retailer using the preference marking of their shoppers could implement other added services.

Registered Digital Marking—the shopper will have a choice to register either at the store level via an in-store kiosk or via the Internet on the retailer's website. If the retailer has a membership program and the shopper is already a member, he/she will be able to register her/his name via an in-store kiosk or retailer's website. The retailer may want to add each registered member onto the sampling system without the need for the shopper to register. In either case, this would allow the shopper to scan his/her membership card and receive a welcome message with his/her name.

As a registered member, the shopper may be given greater choices of service and flexibility derived from his/her Digital Marking such as:

1. Allowing the shopper to create a shopping list of products for family and friends to buy as presents;

2. Provide recommendation/introduction of upcoming products not yet released based on his/her digital marking;

3. If marking of product is also allowed over the retailer's website the retailer could integrate both services. This way regardless where the shopper is (physical store or website) the shopper can review the same information.

### BRIEF DESCRIPTION OF THE DRAWINGS

FIG. 1 is a network diagram of various aspects of the apparatus.

FIGS. 2a, 2b, and 2c are flowcharts of the invention.

FIG. 3 is a schematic of various parts of the apparatus.

FIG. 4 is a schematic of an array used for digitally marking.

### DETAILED DESCRIPTION OF THE PREFERRED EMBODIMENT

The apparatus for digitally marking digital content of the present invention is generally shown in the Figures as reference numeral 10.

The apparatus 10 preferably comprises a means 12 for storing media content; a means 14 for sampling portions of the stored media content from the means 12 for storing the media content; an identification means 30 having identifying indicia 32; and a means 40 for marking selected instances of the sampled portions of the stored media content for future retrieval by the consumer using the identification means 30.

In one aspect, the means 12 for storing media content comprises: a main server 12, which can be either in a store or remote from the store. The main server 12 has large storage devices 13 (hard drives, DVDs, CD-ROMs, etc.) which hold the digital content to be digitally marked.

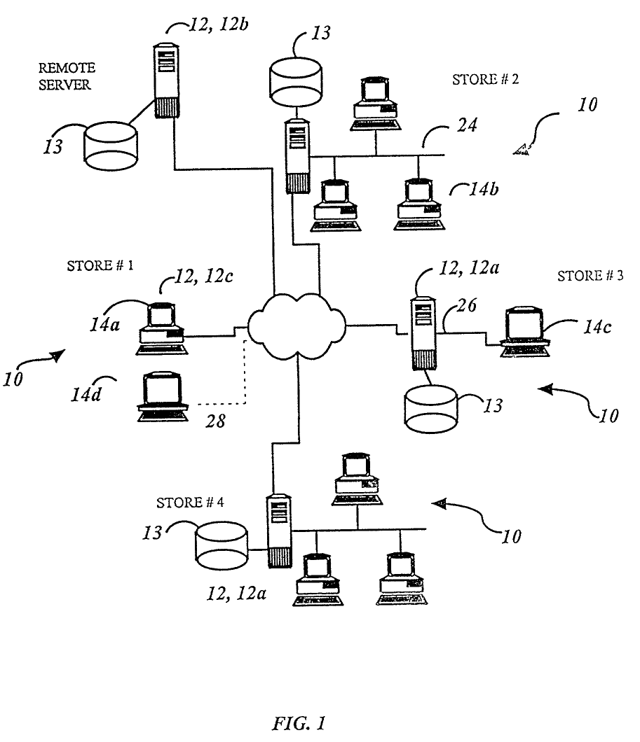

Several embodiments of the main server 12 are shown in FIG. 1.

In a first embodiment, the main server 12 may be in each store, as designated by reference numeral 12a.

In a second embodiment, the main server 12 may be at a remote location, as designated by reference numeral 12b.

In either case, the server 12 may be either a stand-alone machine or the same machine may be used as both a server and a workstation, as designated by reference numeral 12c.

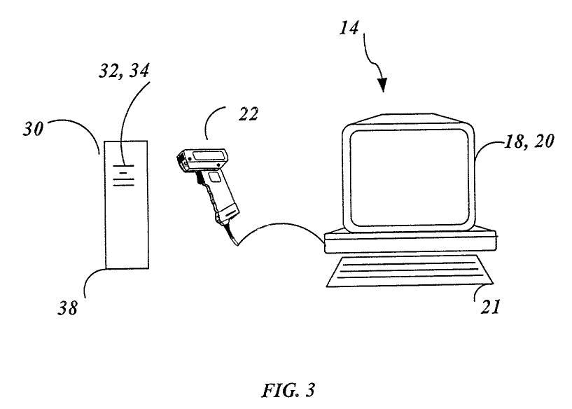

In one aspect of the invention, the means 14 for sampling portions of the stored media content further comprises at least one workstation 14, which may be equipped with a variety of peripherals such as a display screen 18, touch screen 20, keyboard or keypad 21 and a bar code scanner 22, as shown more particularly in FIG. 3.

Each workstation 14 may be connected to a server 12 in several different ways, as shown in FIG. 1.

First, the workstation may be the same machine as the server, as shown by reference numeral 14a.

Second, the workstation may be connected to the server 12 by a local area network 24, as shown by reference numeral 14b.

Third, the workstation may be hard-wired to the server 12 by a wired connection 26 without using a local area network, as shown by reference numeral 14c. Some possible wired connections not using a local area network are described in U.S. Pat. No. 6,133,908, herein incorporated by reference.

Fourth, the workstation may be connected to the server 12 by a wireless connection 28, as shown by reference numeral 14d. Such a wireless connection can use any appropriate technology (radio frequency, infrared, etc.).

The workstation may be any kind of device (such as a keypad/display, computer, thin client, terminal, etc.) that allows a shopper to interact with the apparatus 10. Devices which can be used as the workstations 10 are described in U.S. Pat. No. 6,133,908, herein incorporated by reference.

The main objective of this invention is the means by which digitally sampled content can be marked and its reference stored for future use either by the shopper or the retailer.

To facilitate such a service and to manage the perpetual database of thousands of such marked references and to correlate them with thousands of different shoppers (unique barcodes) requires the use of an identification unique to each shopper. Among many methods to create unique identification means 30, this invention suggests the use of scanning technology to recognize shoppers by scanning a unique barcode 34 as the identifying indicia 32. Such a barcode number can be placed on a numbered certificate 38 on any type of media such as plain paper, plastic, etc. and referred to as a “Digital Marker”. Instructions on how to use the Digital Marking feature as well as other information (advertising) can be printed on the Digital Marker.

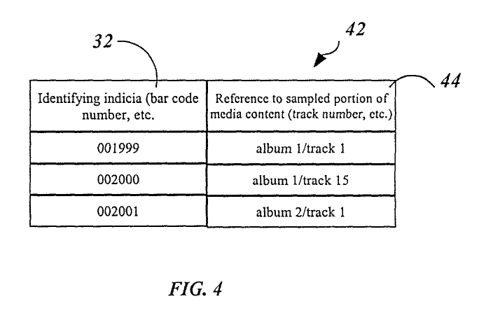

Preferably, the means 40 for marking selected instances of the sample portions of the stored media content for future retrieval is an array 42 referencing the identifying indicia 32 and indicia 44 keyed to the selected instances of the sampled portions of the stored media content. A possible array structure is shown in FIG. 4. However, it will be recognized that a variety of array structures, ranging from the simple structure shown in FIG. 4 to more complex structures such as files and databases, may also be used as the means 40 for marking selected instances of the sample portions. Also, the array 42 may have additional data, such as: type of product, type of media, artist, title, song title, piece, points, date stamp, time stamp, location of the service, etc. The array 42 may be anywhere in the apparatus 10. Preferably, the array 42 is stored in the server 12.

To use the digital marking feature, the shopper picks-up a product (music CD, DVD Video or Game) from the shelf and scans its barcode in order to initiate the digital sampling session. While sampling, the shopper has various options to interact with the sampling station allowing control of the volume, skipping forward or back or, if the sampling station allows, using various menu-driven options, all as described in U.S. Pat. No. 6,133,908. By incorporating the feature of Digital Marking, the shopper will now also have the option of marking any sampled product of their choice for future reference.

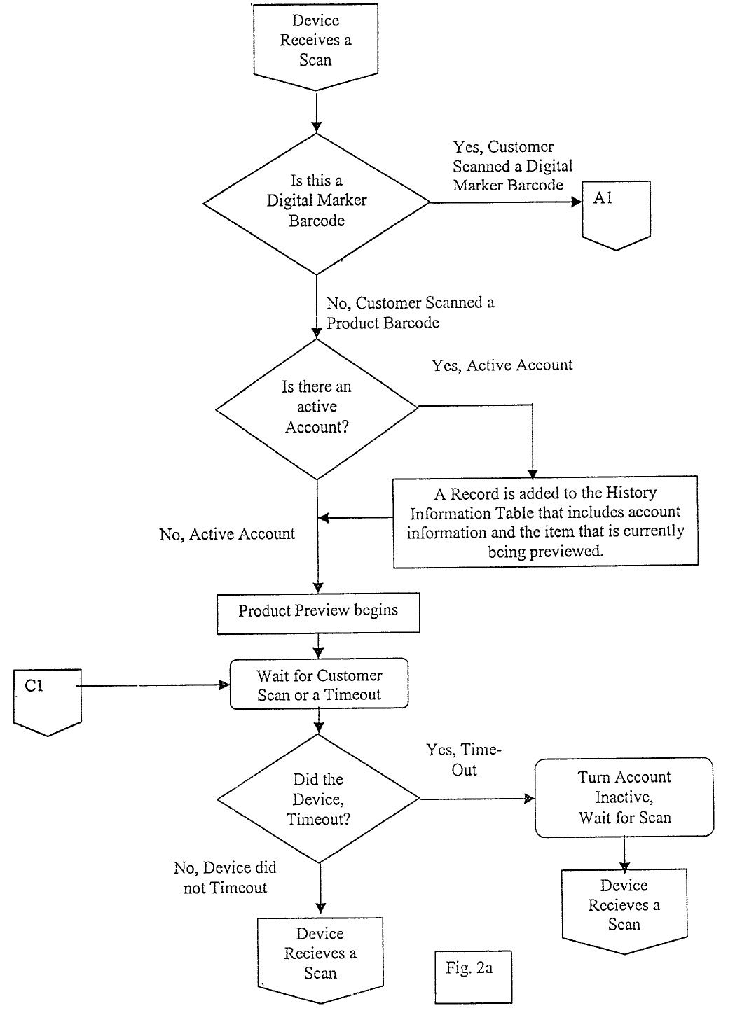

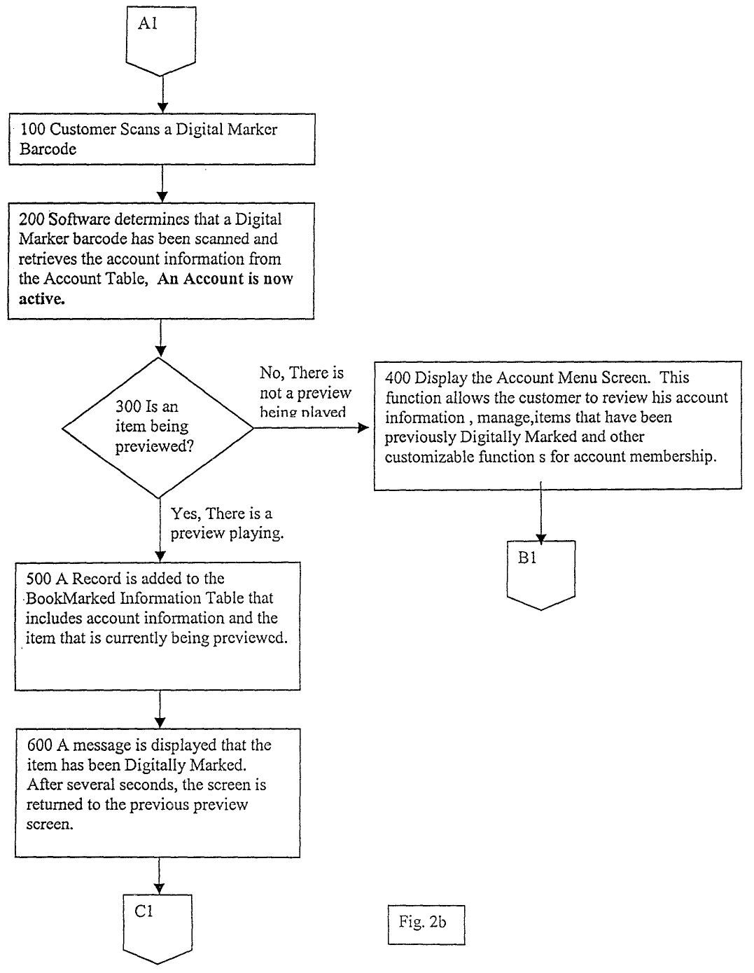

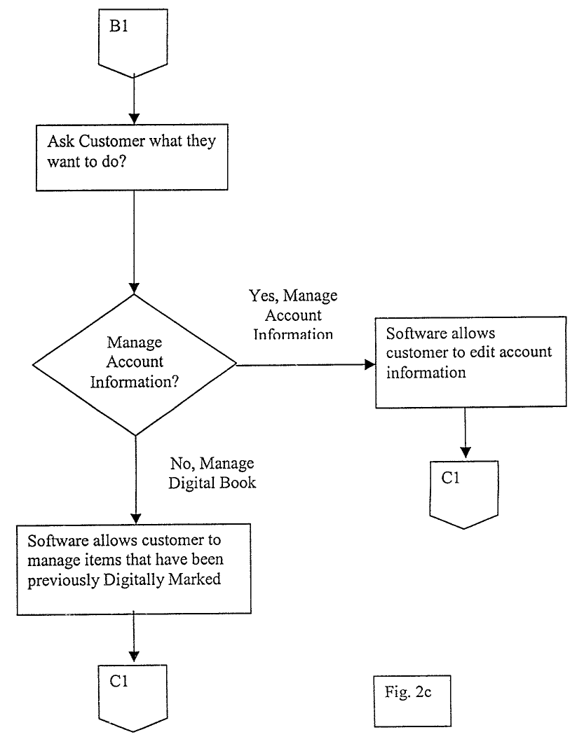

A flowchart of a method of digital marking using the above-described apparatus 10 is shown in FIGS. 2a, 2b and 2c.

To digitally mark the desired product through the use of digital sampling systems, the shopper will preferably use a unique barcode 34 printed on the Digital Marker 38. However, the claimed method includes other ways of entering a unique code from the Digital Marker, such as keying it into a keypad. A digital mark (reference) of a specific product sampled will be initiated by scanning 100 the unique barcode 34 either before a sampling session begins, during the sampling session or after the sampling session or a combination of all. If the shopper scans the unique barcode 34 before initiating the sampling session, the system will track all functions made by the shopper including digital marking. If the shopper scans the unique barcode 34 while the sample is in progress, the system will immediately mark his/her product choice and provide visual and/or audible acknowledgement of the Digital Marking being completed. If the shopper chooses to mark the desired product after a sampling session, the shopper will have a predefined amount of time to make the desired marks (scan a Digital Marker), and if not scanned within an allowed time period, the sampling station will default to an idle mode.

Processing common to product barcode scanning and digital marker scanning is shown in FIG. 2a. If the device receives a scan and determines that a digital marker barcode has been scanned, digital marker processing begins as shown in FIG. 2b.

If a product barcode has been scanned, the software determines if there is an active account. If there is an active account, a record is added to the History Information Table that includes account information and the item that is currently being previewed.

If there is not an active account, the apparatus allows the customer to preview the product as usual.

The software then waits for another scan or a timeout.

If the device times out, the software makes the account inactive and prepares to receive another scan.

If the device did not time out, it received a scan and processing starts over as previously described.

Once the customer scans the digital marker barcode, software 200 (FIG. 2b) determines that a digital marker has been scanned and retrieves account information corresponding to the unique digital code.

The software then determines 300 whether a content item is currently being previewed at the workstation 14.

If an item is not currently being previewed (as for example, when the consumer enters the barcode 34 at a later time than when the digital marker was first entered), the software 400 displays an Account Menu Screen that allows the customer to review his account information, manage items that have been previously digitally marked, and other customizable functions for account membership, as shown in FIG. 2b.

If the software determines that an item is currently being previewed, the software 500 adds a record to a History Information Table (such as the array 42 shown in FIG. 4) that includes account information and a reference to the item that is currently being previewed.

The software 600 then displays a message that the item has been digitally marked. After several seconds, the screen is returned to the previous screen.

The software then waits for the next sampling session or scanning of a digital marker (C1, FIG. 2a).

At anytime after digital marking has been completed, using the Digital Marker, the shopper can view and sample or delete any of the previously marked items at anytime. Although the preferred method comprises scanning the unique barcode 34, any other method of entering the unique barcode 34 may be used. For example, the unique barcode 34 could be keyed in either at the store or from a remote location (such as the consumer's home) using the Internet.

If more than one physical store is networked together, the shopper can view and sample the digitally marked product regardless in which store the shopper uses the Digital Marker. This is accomplished by either distributing the entire Shopper's Reference Databases (consolidated from all stores into a single database) to each physical store on a scheduled basis or by sharing/pulling it from a single remote facility to all stores via a private network or Internet.

The present invention may be embodied in other specific forms without departing from the spirit or essential attributes thereof, and it is therefore desired that the present embodiment be considered in all respects as illustrative and not restrictive.

What is claimed:

1. Apparatus for allowing a consumer to digitally mark media content and later retrieve portions of the marked media content keyed to that consumer, comprising:
a. means for storing media content;
b. means for sampling portions of the stored media content from the means for storing media content;
c. identification means, having identifying indicia; and
d. means for marking selected instances of the sampled portions of the stored media content for future retrieval by the consumer using the identification means.

2. The apparatus of claim 1, wherein the means for storing media content comprises a server computer.

3. The apparatus of claim 2, wherein the means for sampling portions of the stored media content comprises a workstation connected to the server computer.

4. The apparatus of claim 1, wherein the identification means comprises a numbered certificate.

5. The apparatus of claim 4, wherein the consumer remains anonymous.

6. The apparatus of claim 4, wherein the consumer's identity is keyed to the numbered certificate.

7. The apparatus of claim 5, wherein the identifying indicia further comprises a bar code.

8. The apparatus of claim 6, wherein the numbered identifying indicia further comprises a bar code.

9. The apparatus of claim 1, wherein the means for marking further comprises an array referencing the identifying indicia and indicia keyed to the selected instances of the sampled portions of the stored media content.

10. Apparatus for allowing a consumer to digitally mark portions of media content and later retrieve the marked portions uniquely keyed to that consumer, comprising:
a. storage for storing the media content;
b. a server computer accessing the media content storage;
c. a workstation interacting with the server computer to allow the consumer to sample portions of the stored media content;
d. a plurality of portable identification means, separate from the server and the workstation, and including identifying indicia unique to each instance of the portable identification means; and
e. an array containing references to the identifying indicia and indicia keyed to selected instances of the sampled portions of the stored media content.

11. The apparatus of claim 10, wherein the server computer and the workstation are co-located.

12. The apparatus of claim 10, wherein the server computer is remote from the workstation.

13. The apparatus of claim 11, wherein the workstation and the server computer are the same machine.

14. The apparatus of claim 11, wherein the server computer and the workstation are connected by a local area network.

15. The apparatus of claim 11, wherein the server computer and the workstation are connected by a hard-wired connection not involving a local area network.

16. The apparatus of claim 11, wherein the server computer and the workstation are connected by a wireless connection.

17. The apparatus of claim 10, wherein the identifying means is a numbered certificate.

18. The apparatus of claim 17, wherein the identifying indicia is a bar code on the numbered certificate.

19. The apparatus of claim 10, wherein the array further comprises indicia of the consumer's identity.

20. Apparatus for allowing a consumer to digitally mark portions of media content and later retrieve the marked portions uniquely keyed to that consumer, comprising:
a. storage for storing the media content;
b. a server computer accessing the media content storage;
c. a workstation interacting with and connected to the server computer to allow the consumer to sample portions of the stored media content;
d. a plurality of portable digital markers, separate from the server and the workstation, and including a bar code unique to each instance of the portable digital marker; and
e. a shopper's reference database containing references to the unique bar codes and references to the sampled portions of the stored media content.

21. The apparatus of claim 20, wherein the shopper's reference database further comprises indicia of the consumer's identity.

22. A method of allowing a consumer to digitally mark portions of media content and later retrieve the marked portions uniquely keyed to that consumer, comprising the steps of:
a. retrieving a sample of the media content;
b. entering a unique identifier;
c. keying the retrieved sample to the unique identifier; and
d. at a later time, retrieving the sample by entering the unique identifier.

23. The method of claim 22, wherein the step of entering a unique identifier further comprises scanning a unique barcode from a numbered certificate.

24. The method of claim 23, wherein the step of entering a unique identifier further comprises entering consumer information associated with the unique barcode.

25. The method of claim 23, wherein the step of retrieving the sample further comprises scanning the unique barcode from the numbered certificate.

26. The method of claim 22, further comprising the step of distributing a database containing the unique identifier and samples keyed to the unique identifier from a central location to at least one non-central location.

27. The method of claim 26, wherein the database is distributed on a scheduled basis.

28. The method of claim 26, wherein the database is distributed upon request from the non-central location.

29. The method of claim 22, further comprising the step of entering consumer information and associating the consumer information with the unique identifier.
